(19) United States
(12) Patent Application Publication
(10) Pub. No.: US 2003/0044012 A1
(43) Pub. Date: Mar. 6, 2003

(54) System and method for using a profile to encrypt documents in a digital scanner

(75) Inventor: Guy Eden, Tustin Ranch, CA (US)

Correspondence Address: David C. Ripma, Patent Counsel, Sharp Laboratories of America, Inc., 5750 NW Pacific Rim Boulevard, Camas, WA, 98607, US

(73) Assignee: Sharp Laboratories of America, Inc.

(21) Appl. No.: 09/944,684

(22) Filed: Aug. 31, 2001

(51) Int. Cl. H04N 1/44

(52) U.S. Cl. 380/243

(57) ABSTRACT

A system and method are provided for secure document transmission in a digital scanner. The method comprises: generating a plurality of passwords for a corresponding plurality of user groups; creating profiles having an address field and an encryption field; storing the profiles in a directory in response to the generated password; selecting a profile from the directory; scanning a document; encrypting the document in response to the encryption field of the selected profile; and, sending the encrypted document in response to the address field of the selected profile. Selecting a profile includes selecting a profile having either an email address or a file transfer protocol (FTP) address. Further, selecting a profile includes selecting a profile having either a symmetric or asymmetric (public) key encryption field. Then, creating profiles includes storing either the symmetric or public keys in the created profiles.

### BACKGROUND OF THE INVENTION

1. Field of the Invention

This invention generally relates to digital copiers or scanners and, more particularly, to a system and method of using a profile to aid in the encryption of documents processed at a digital scanning device.

2. Description of the Related Art

Digital copiers can have multiple functions, such as scanning, copying, printing, and faxing. Such a multi-function device is often referred to as a multifunctional peripheral (MFP), however, for the sake of simplicity such devices will be generally referred to herein as a scanner. State of the art scanners scan a document and send the binary image across the wire, via the unsecured Internet. This constitutes a serious security issue, especially when the document is intended to be confidential.

It is often desirable to send a document in a manner so that only one person, the intended recipient, can decipher it. Conventionally, the sender transmits the scanned documents to their own terminal, which resides within a ‘friendly’ local area network (LAN). An encryption algorithm is established at the sender's terminal, and the encrypted document is transmitted from the sender's terminal. That is, the user must scan the document on a scanner, which resides on a trusted sub-network, usually in the same sub-network as the sender's terminal. Thus, the data never ‘leaves’ the secure LAN and no eavesdropper can intercept the packets leaving the scanner. The sender then uses their favorite encryption algorithm from their terminal, upon receiving the images from the scanner. The sender encrypts the data and sends it, using an email application for example. This constitutes a cumbersome three-stage process, and it's not entirely safe, as the eavesdropper may reside between the scanner and the terminal. For example, the System Administrator may be untrustworthy, or a malicious packet recorder may be planted in the sub-network by an eavesdropper.

Given a conventional scanner, a user can transfer sensitive documents to the recipient in a secure manner by splitting the task into three sub-tasks:

the user scans documents to themselves;

the user approaches their own terminal, and encrypts all the scanned images; and, the user launches their email application, attaches the ciphered objects to the email message, looks up the recipient's email address, and sends the email message to the recipient.

It would be advantageous if an encrypted document could be sent from a scanner using a simple process.

It would be advantageous if the security surrounding the encryption of documents sent from a scanner could be improved.

### SUMMARY OF THE INVENTION

The current invention solves the above-mentioned security problems by encrypting the images at the scanner level, and then sending the images directly to the recipient. The present invention does not rely on any secure connection, or on a trusted sub-network. Usability wise, the current invention requires less user intervention. As a matter of fact, the encryption process is made transparent to the user. That is, the sending of an encrypted image does not take any more steps than it takes to send an image in a conventional, unencrypted manner.

Accordingly, a method is provided for secure document transmission in a digital scanner. The method comprises: generating a password for a plurality of user groups; creating profiles having an address field and an encryption field; storing the profiles in a directory in response to the generated password; selecting a profile from the directory; scanning a document; encrypting the document in response to the encryption field of the selected profile; and, sending the encrypted document in response to the address field of the selected profile.

Selecting a profile includes selecting a profile having either an email address or a file transfer protocol (FTP) address. Further, selecting a profile includes selecting a profile having either a symmetric or asymmetric key encryption field. Then, creating profiles includes storing either the symmetric or public keys in the created profiles.

Additional details of the above-mentioned method for secure transmissions, and a digital scanner secure document transmission system are provided below.

### BRIEF DESCRIPTION OF THE DRAWINGS

FIG. 1 is a schematic block diagram of the present invention digital scanner secure document transmission system.

FIG. 2 depicts an exemplary profile directory of FIG. 1.

FIG. 3 is an exemplary public key, such as represented by the public key of the profile directory in FIG. 2.

FIG. 4a illustrates the process of setting up a profile in the present invention system.

FIG. 4b illustrates the process of sending an encrypted document using the present invention system.

FIG. 5 is a flowchart illustrating the present invention method for secure document transmission in a digital scanner.

### DETAILED DESCRIPTION OF THE PREFERRED EMBODIMENTS

Some portions of the detailed descriptions that follow are presented in terms of procedures, steps, logic blocks, codes, processing, and other symbolic representations of operations on data bits within a microprocessor or memory. These descriptions and representations are the means used by those skilled in the data processing arts to most effectively convey the substance of their work to others skilled in the art. A procedure, microprocessor executed step, application, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a microprocessor device. It has proven convenient at times, principally for reasons of common usage, to refer to these signals as bits, values, elements, symbols, characters, terms, numbers, or the like. Where physical devices, such as a memory are mentioned, they are connected to other physical devices through a bus or other electrical connection. These physical devices can be considered to interact with logical processes or applications and, therefore, are “connected” to logical operations. For example, a memory can store or access code to further a logical operation, or an application can call a code section from memory for execution. The various connections between elements of a described system or device are not always specifically recited, as these connections are understood to exist.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “connecting” or “translating” or “displaying” or “prompting” or “supplying” or “allocating” or “establishing” or “selecting” or “storing” or “receiving” or “determining” or “displaying” or “recognizing” or the like, refer to the action and processes of in a microprocessor system that manipulates and transforms data represented as physical (electronic) quantities within the computer system's registers and memories into other data similarly represented as physical quantities within the wireless device memories or registers or other such information storage, transmission or display devices.

The following terminology may also prove beneficial in understanding the description of the present invention:

Plaintext: a text file or a binary file, for example a .JPG image file, which is not encrypted, and which can be opened and viewed by all users;

Ciphertext: An encrypted plaintext message;

Symmetric encryption algorithms: encryption algorithms in which the sender and the receiver share the same key. When Alice and Bob are communicating, they need to agree on a key. The key is used to both encrypt the message and decrypt it. Alice would make up a key, encrypt her message using the key, and send the ciphertext to Bob. Bob, in turn, would use the agreed upon key, in order to be able to decrypt the message;

Public key encryption algorithm: (a.k.a.: asymmetric encryption) is an algorithm, which uses one key (called a public key) for encrypting the message, and a second key for decrypting it. If Bob wants to send a ciphertext to Alice, he would use her public key for the task. While everyone can encrypt a message using Alice's public key, Alice is the only one who can decipher the message.

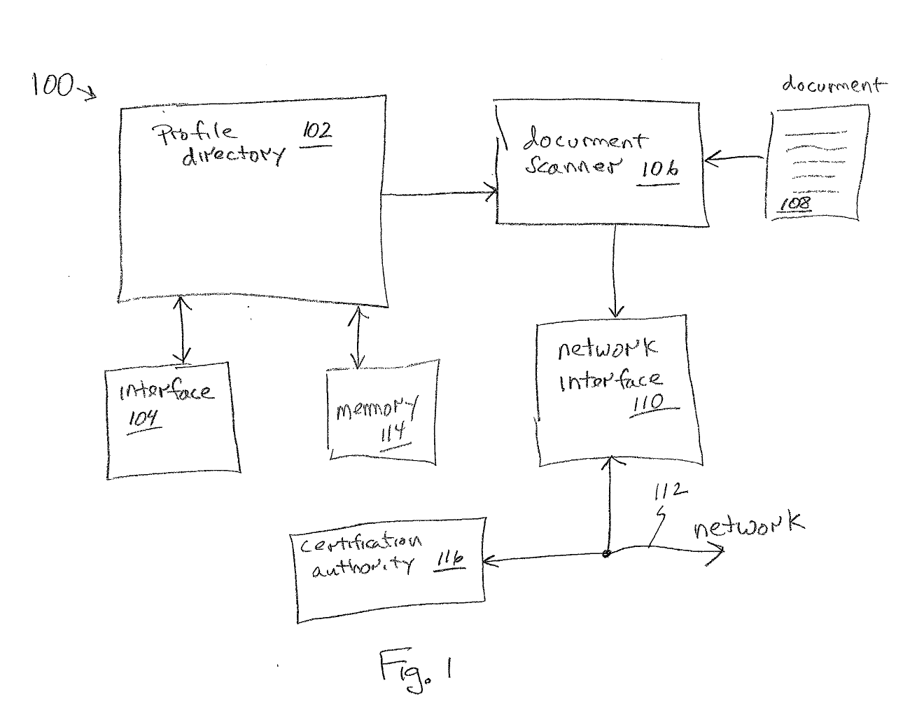

FIG. 1 is a schematic block diagram of the present invention digital scanner secure document transmission system. The system 100 comprises a profile directory 102 having an interface, or user interface 104 for selecting profiles having an address field and an encryption field. The interface 104 is also used to create profiles having address and encryption fields. The profile directory supplies selected profiles with an encryption field. The system 100 also comprises a document scanner 106 for encrypting documents 108 in response to selected profile encryption fields, and a network interface 110 for transmitting the encrypted documents on a network 112. The network 112 can be the Internet, a conventional intranet, or LAN. The system 100 further comprises a memory 114 for storing the profiles. The interface 104 can be embodied as a front panel, keypad, mouse, touchscreen, a connected computer terminal, or the like.

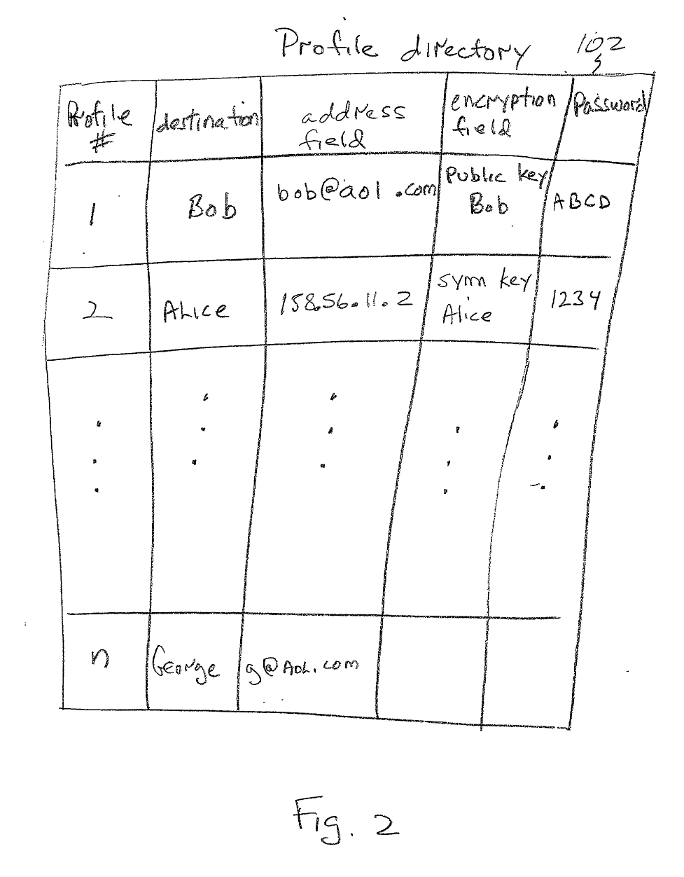

FIG. 2 depicts an exemplary profile directory 102 of FIG. 1. The profile directory 102 supplies selected profiles to the document scanner. The profiles include an address field, in addition to the encryption field. Returning briefly to FIG. 1, the network interface 110 transmits the encrypted documents in response to the address field of the selected profile, as well as in response to the encryption field. Although the profile directory 102 is shown with n profiles, there is no limitation to the number of profiles that can be managed by the profile directory.

Contrasting FIGS. 1 and 2, the profile directory 102 has an interface 104 for accepting destinations and assigning each profile to a corresponding destination. Then, profiles can be selected from the profile directory 102 in response to entering the destination. For example, profile #1 can be selected by having a user enter the destination of “Bob”.

The profile directory 102 supplies selected profiles having an address selected from the group including email addresses and file transfer protocol (FTP) addresses (more specifically an FTP directory with an IP address). As shown, the address associated with profile #1 is an email address, whereas the address associated with profile #2 is an FTP IP address.

The profile directory 102 supplies selected profiles having an encryption field selected from the group including symmetric and asymmetric keys. The terms asymmetric and public, as used herein, are interchangeable. For example, the encryption field associated with profile #1 is a representation of an asymmetric public key, whereas the encryption field associated with profile #2 is a representation of a symmetric key.

When, the profile directory 102 supplies selected profiles having an asymmetric key, the memory 114 stores the public keys corresponding to each profile. Likewise, when the profile directory 102 supplies selected profiles having a symmetric key, the memory 114 stores the symmetric keys corresponding to each profile. Note, a profile directory could simultaneously manage profiles with both kinds of encryption fields.

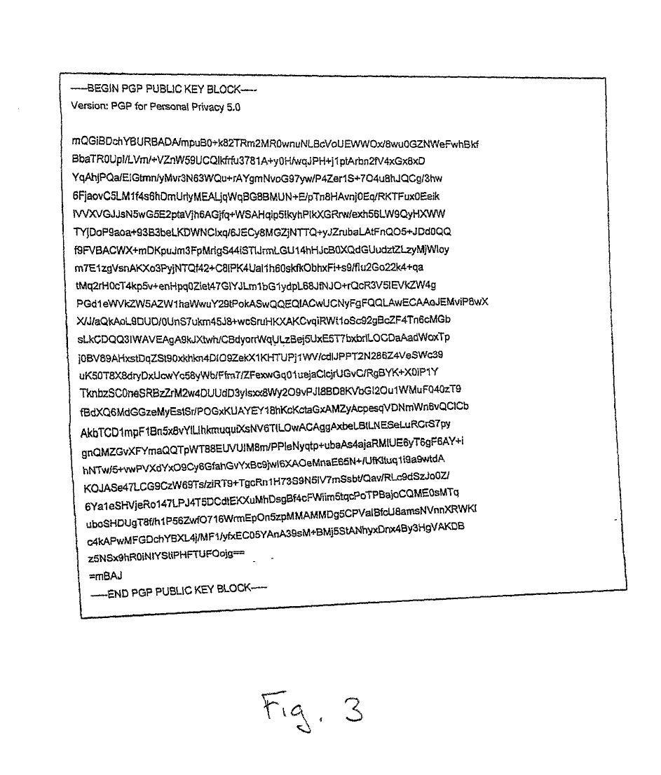

FIG. 3 is an exemplary public key, such as represented by the public key of the profile directory in FIG. 2.

Returning to FIGS. 1 and 2, in some aspects of the invention, the profile directory 102 has an interface 104 for generating passwords. The profile directory 102 creates profiles for a plurality of user groups in response to the generated passwords. For example, each profile in the profile directory can be assigned to a different user group. Note that a user group may include one or more users. Each user group creates, or edits a profile, with a corresponding encryption field, by entering a password. This security feature prevents an eavesdropper from substituting keys, and prevents someone outside the user group from tampering with a profile.

In some aspects of the invention, the keys are not stored in the memory 114. Then, the system uses a certification authority (CA) 116 to store the public keys. The profile directory 102 supplies a selected profile having a link to the certification authority 116. For example, the link may be a hypertext link or a separate profile with a destination (the CA) and a field to identify the public key being requested. The network interface 112 negotiates with the certification authority 116 for a public key corresponding to the selected profile. The document scanner 106 uses the public key signed by the certification authority 116 to encrypt the document 108.

In some aspects of the invention, such as when the document 108 is complex and the encryption process would be prohibitively burdensome, a two-step encryption process is used. The document scanner 106 generates a random session key and encrypts the document with the session key using a symmetric algorithm. The document scanner 106 then encrypts the session key with an asymmetric algorithm using the selected profile public key. The network interface 112 transmits the encrypted session key with the encrypted document.

In some aspects of the invention, a profile is created in the profile directory 102 that has a plurality of addresses and a corresponding plurality of public keys. This kind of profile can be referred to as a distribution list. When this type of profile is selected, and the profile encryption field includes only public keys, the document scanner 106 is able to encrypt a document into a single encrypted document using an asymmetric algorithm, instead of having to separately encrypt the document for each destination. Thus, the network interface 110 is able to send the single encrypted document to each of the plurality of addresses in the selected profile.

### SYSTEM OPERATION

Conventional systems use a profile, or the destination field of a profile, to accommodate the address to which a scanned document is sent. The profile consists of an email address of the recipient, or an FTP address (IP address, username, password, and destination directory). The sender sets up the profiles. A common scenario is for the sender to acquire the recipient's email address/FTP IP address by email, and to initiate a new profile addition to the scanner's list of existing profiles.

The present invention system utilizes the profiles for the addressing task, and adds an additional field to the profile. The extra field is the encryption key of the recipient. A public key provides a greater level of security than a symmetric key. The public key, as it's name states, is public. It's not an element that is intended to be secret, and it is usually published on key servers over the Internet. Thus, there is no security compromise in storing the public key in the scanner's database or memory. If an attack is made, the attackers can lookup the public key in the profile, and try to intercept the message. However, the attacker is out of luck without the recipient's private key. Only with the private key can a ciphertext be decrypted, and thus only the recipient who keeps his private key secret, will be able to decrypt the message.

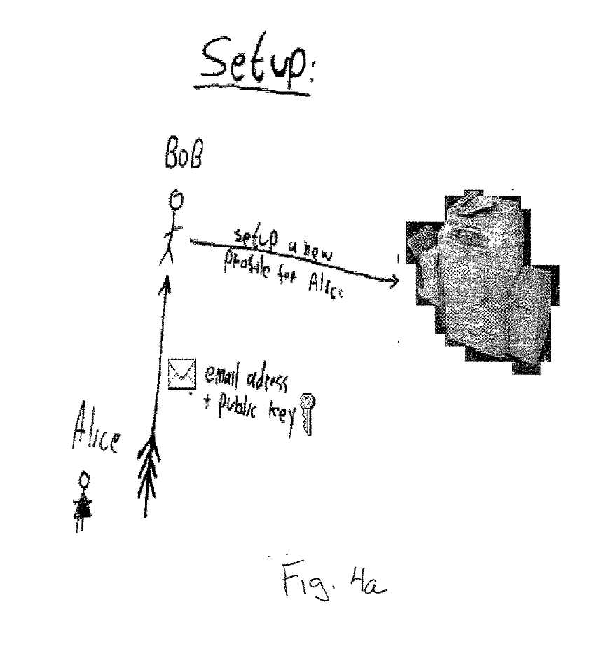

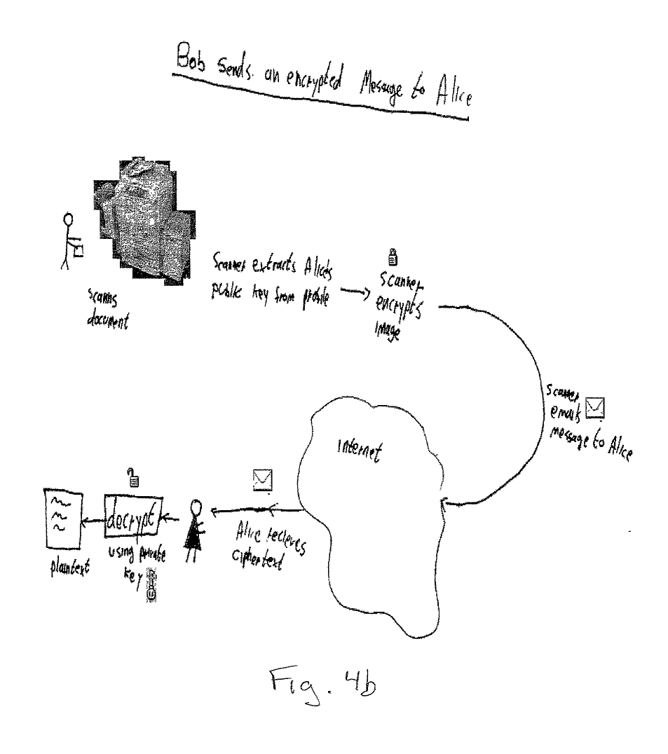

FIG. 4a illustrates the process of setting up a profile in the present invention system. As mentioned earlier, the sender sets up the recipient's public key as one of the fields in the profile. Later, when the sender scans a document, the destination (profile) with the recipient's address is selected.

FIG. 4b illustrates the process of sending an encrypted document using the present invention system. The sender scans their document, and the scanner extracts the destination address and the public key from the profile. The scanner encrypts the scanned image using the public key. The image is then sent to the recipient using the Internet. The recipient receives the ciphertext. They are the sole party able to view the document because it is encrypted using their public key, and the recipient is the sole owner of their private key.

Public key encryption is a logical encryption algorithm to use since the profiles reside in a public storage place, accessible to everyone. If a symmetric algorithm is selected, then the sender must store a passphrase on the scanner, which is open to attack, defeating the whole purpose the encryption process. Alternately, the passphrase or symmetric key is transmitted from the sender's terminal to the scanner prior to every scan. Again, the sent key is open to attack.

### Possible Attacks

1. Eve, the attacker could swap the public key (Alice's public key) in the profile directory with her own public key. Bob would then scan the image. The scanner would encrypt the image using Eve's public key, and email it to Alice. Now, not only will Alice not be able to see her plaintext, but Eve has intercepted the message and can decrypt it, because it was encrypted using her public key. The secret has been reveled.

2. Another attack possible is a brute force attack. That is, the eavesdropper records the ciphered message, and then tries all possible combinations of the private key.

### Solutions

1. One solution to the first kind of attack is for the sender to lookup a recipient's public key on a trusted authority's database, such as VeriSign. The trusted authority issues the signed desired public key. This prevents the man in the middle attack. The trusted authority is the only one who could have issued the signature, and when the sender verifies the signature against the authority's public key, it's safe to assume the public key does belong to the recipient. At this point, the sender saves the recipient's public key in a safe place. However, the scanner contains data (the profiles), in a public place and is located in a public place accessible to all users. The solution is to issue passwords to users. Bob has entered Alice's public key into a profile, and Bob is the only one who will be authorized to change or to delete this profile. Eve cannot change the public key, and thus the message is not legible, as far as she's concerned.

2. One solution to the second kind of attack is to use a longer length key. If the private key is n bits long, then there are 2n possible keys. On the average, a computer would have to try about half the possible keys before finding the correct one. If the key is 112 bits long, then even a machine a billion times faster than Deep Crack (a machine that can brute force the DES algorithm and can find a 56-bit data encryption standard (DES) key in an average of 4.5 days.) would take a million years to try all 2112 keys and recover the plaintext. The brute-force algorithms scale linearly. A machine twice as fast would take half the time to crack a key, but the complexity of cracking a key is exponential, in respect to the key length.

Thus, the preferred embodied algorithm used for encrypting messages is Rivest-Shamir-Adleman (RSA), which is a public key encryption algorithm. The current invention can also work using a symmetric algorithm, in which the password is stored on the scanner. In a trusted environment (i.e. home, or small office) this type of encryption is sufficient. But in a stringent environment, where security is extremely critical, it's recommended that a public key algorithm be used.

Other known public key encryption algorithms are: PGP (pretty good privacy), ElGamal, and elliptic curves. Other possible acceptable choices are: Ipsec, which secures IP traffic across the Internet. SSL (Secure Sockets Layer) secures WWW connections. PGP and S/MIME secure email messages.

It is worth to note that the “strength” of the encryption is determined by the size of the key. By publishing their own public key, the recipients determine the security of the communication. If the user wants to compromise security and achieve more speed, they will provide a shorter public key. The scanner is able to deal with any key length provided.

It is also worth to note that for very large images, it's possible for the scanner to generate a session key, which is a key randomly generated for the current session. Then, the scanner would encrypt the session key using the recipient's public key, and encrypt the image using the session key with a symmetric algorithm (i.e. DES). Symmetric algorithms are about 1000 faster to encrypt/decrypt than are asymmetric algorithms. The receiver gets the encrypted session key, decrypts it using their private key, and obtains the session key. The session key is then used to decipher the image.

Scanners that support distribution lists would store the public key of each member in the distribution list, as part of the profile. Thus, the profile would contain n destinations, and n public keys. When the user scans a document, the scanner encrypts the image for all n recipients. This generates only one file, as the RSA algorithm enables multiple key encryptions. A ciphertext is generated that can be deciphered by any one of the n recipients. It is not necessary to create a separate profile for each recipient, or to encrypt the image for individuals.

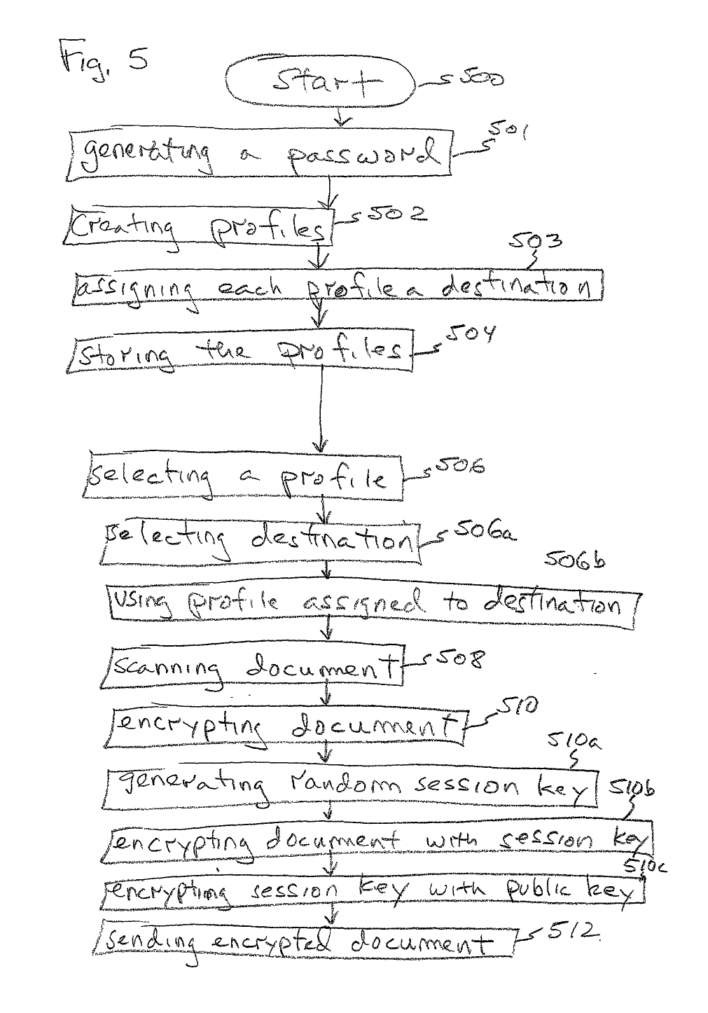

FIG. 5 is a flowchart illustrating the present invention method for secure document transmission in a digital scanner. Although the method is depicted as a sequence of numbered steps for clarity, no order should be inferred from the numbering unless explicitly stated. The method starts at Step 500. Step 502 creates profiles having an address field and an encryption field. Step 504 stores the profiles in a directory. Step 506 selects a profile having an encryption field and an address field from the directory. Step 508 scans a document. Step 510 encrypts the document in response to the encryption field of the selected profile. Step 512 sends the encrypted document in response to the address field of the selected profile.

In some aspects of the invention, a further step, Step 503 assigns each profile to a corresponding destination. Then, selecting a profile in Step 506 includes substeps. Step 506a selects a destination. Step 506b uses the profile assigned to the selected destination.

Selecting a profile in Step 506 includes selecting a profile having an address selected from the group including email addresses and file transfer protocol (FTP) addresses. Selecting a profile in Step 506 includes selecting a profile having an encryption field selected from the group including symmetric and asymmetric keys.

When Step 506 includes selecting a profile having a asymmetric key, creating profiles in Step 502 includes storing public keys in the created profiles. Likewise, when Step 506 includes selecting a profile having a symmetric key, creating profiles in Step 502 includes storing symmetric keys in the created profiles.

In some aspects of the invention, creating profiles in Step 502 includes creating profiles for a plurality of user groups. Then, the method further comprises Step 501 of generating a plurality of passwords for the corresponding plurality of user groups. Storing the profiles in a directory in Step 504 includes storing profiles in a profile directory, in response to the generated password.

In some aspects of the invention, selecting a profile in Step 506 includes selecting a profile having a link to a certification authority storing a public key. Then, encrypting the document using the encryption field from the selected profile in Step 510 includes using the public key signed by the certification authority to encrypt the document.

In other aspects of the invention, encrypting the document using the encryption field from the selected profile in Step 510 includes substeps. Step 510a generates a random session key. Step 510b encrypts the document with the session key using a symmetric algorithm. Step 510c encrypts the session key with an asymmetric algorithm using the selected profile public key. Then, sending the encrypted document to the address from the selected profile in Step 512 includes sending the encrypted session key.

In some aspects of the invention, creating profiles in Step 502 includes creating a profile with a plurality of addresses and a corresponding plurality of public keys. Encrypting the document in Step 510 includes generating a single encrypted document using an asymmetric algorithm, and sending the encrypted document in Step 512 includes sending the single encrypted document to each of the plurality of addresses in the profile.

A system and method have been provided for using a profile to secure transmissions from a digital scanner. Examples of scanner using a profile with an address field, encryption field, and a password field have been given. However, the present invention is not limited to any particular definition of profile. Other variations and embodiments of the invention will occur to those skilled in the art.

We claim:

1. In a digital scanner, a method for secure document transmission, the method comprising:
selecting a profile having an encryption field;
scanning a document; and,
encrypting the document in response to the encryption field of the selected profile.

2. The method of claim 1 wherein selecting a profile includes selecting a profile having an address field; and,
the method further comprising:
sending the encrypted document in response to the address field of the selected profile.

3. The method of claim 2 further comprising:
creating profiles having an address field and an encryption field;
storing the profiles in a directory; and,
wherein selecting a profile includes selecting a profile from the directory.

4. The method of claim 3 further comprising:
assigning each profile to a corresponding destination; and,
wherein selecting a profile includes:
selecting a destination; and,
using the profile assigned to the selected destination.

5. The method of claim 3 wherein selecting a profile includes selecting a profile having an address selected from the group including email addresses and file transfer protocol (FTP) addresses.

6. The method of claim 3 wherein selecting a profile includes selecting a profile having an encryption field selected from the group including symmetric and asymmetric (public) keys.

7. The method of claim 6 wherein selecting a profile includes selecting a profile having an asymmetric key; and,
wherein creating profiles includes storing public keys in the created profiles.

8. The method of claim 6 wherein selecting a profile includes selecting a profile having a symmetric key; and,
wherein creating profiles includes storing symmetric keys in the created profiles.

9. The method of claim 3 wherein creating profiles includes creating profiles for a plurality of user groups;
the method further comprising:
generating a plurality of passwords for the corresponding plurality of user groups; and,
wherein storing the profiles in a directory includes storing profiles in a profile directory, in response to the generated password.

10. The method of claim 3 wherein selecting a profile includes selecting a profile having a link to a certification authority storing a public key; and,
wherein encrypting the document using the encryption field from the selected profile includes using the public key signed by the certification authority to encrypt the document.

11. The method of claim 7 wherein encrypting the document using the encryption field from the selected profile includes:
generating a random session key;
encrypting the document with the session key using a symmetric algorithm;
encrypting the session key with an asymmetric algorithm using the selected profile public key; and,
wherein sending the encrypted document to the address from the selected profile includes sending the encrypted session key.

12. The method of claim 6 wherein creating profiles includes creating a profile with a plurality of addresses and a corresponding plurality of public keys;
wherein encrypting the document includes generating a single encrypted document using an asymmetric algorithm; and,
wherein sending the encrypted document includes sending the single encrypted document to each of the plurality of addresses in the profile.

13. In a digital scanner, a method for secure document transmission, the method comprising:
generating a password;
creating profiles having an address field and an encryption field;
storing the profiles in a directory in response to the generated password;
selecting a profile from the directory;
scanning a document;
encrypting the document in response to the encryption field of the selected profile; and,
sending the encrypted document in response to the address field of the selected profile.

14. A digital scanner secure document transmission system, the system comprising:
a profile directory having an interface for selecting profiles with an encryption field;
a document scanner for encrypting documents in response to selected profile encryption field; and,
a network interface for transmitting the encrypted documents.

15. The system of claim 14 wherein the profile directory supplies selected profiles with an address field; and,
wherein the network interface transmits the encrypted documents in response to the address field of the selected profile.

16. The system of claim 15 further comprising:
a memory for storing the profiles; and,
wherein the profile directory has an interface for creating profiles having an address field and an encryption field;

17. The system of claim 16 wherein the profile directory has an interface for accepting destinations and assigning each profile to a corresponding destination; and,
wherein profiles are selected from the profile directory in response to entering the destination.

18. The system of claim 16 wherein the profile directory supplies selected profiles having an address selected from the group including email addresses and file transfer protocol (FTP) addresses.

19. The system of claim 16 wherein the profile directory supplies selected profiles having an encryption field selected from the group including symmetric and asymmetric (public) keys.

20. The system of claim 19 wherein the profile directory supplies selected profiles having an asymmetric key; and, wherein the memory stores the public keys corresponding to each profile.

21. The system of claim 19 wherein the profile directory supplies selected profiles having a symmetric key; and, wherein the memory stores the symmetric keys corresponding to each profile.

22. The system of claim 16 wherein the profile directory has an interface for generating passwords, the profile directory creating profiles for a plurality of user groups in response to the generated passwords.

23. The system of claim 16 further comprising:
a certification authority storing public keys;
wherein the profile directory supplies a selected profile having a link to the certification authority;
wherein the network interface negotiates with the certification authority for a public key corresponding to the selected profile; and,
wherein the document scanner uses the public key signed by the certification authority to encrypt the document.

24. The system of claim 20 wherein the document scanner generates a random session key and encrypts the document with the session key using a symmetric algorithm;
wherein the document scanner encrypts the session key with an asymmetric algorithm using the selected profile public key; and,
wherein the network interface transmits the encrypted session key with the encrypted document.

25. The system of claim 19 wherein the profile directory supplies a selected profile with a plurality of addresses and a corresponding plurality of public keys;
wherein the document scanner encrypts the document into a single encrypted document using an asymmetric algorithm; and,
wherein the network interface sends the single encrypted document to each of the plurality of addresses in the selected profile.
